(19) United States
(12) Patent Application Publication
(10) Pub. No.: US 2014/0244517 A1
(43) Pub. Date: Aug. 28, 2014

(54) Incremental Batch Method for Transforming Event-driven Metrics and Measures within a Map/Reduce Data Center

(71) Applicants: Steven R. Carr, SAN JOSE, CA (US); Bruce Blaine Lacey, FOSTER CITY, CA (US)

(72) Inventors: Steven R. Carr, SAN JOSE, CA (US); Bruce Blaine Lacey, FOSTER CITY, CA (US)

(73) Assignee: CARRIER IQ, INC., SUNNYVALE, CA (US)

(21) Appl. No.: 14/221,545

(22) Filed: Mar. 21, 2014

Related U.S. Application Data
(63) Continuation-in-part of application No. 14/142,204, filed on Dec. 27, 2013.
(60) Provisional application No. 61/769,188, filed on Feb. 25, 2013.

(51) Int. Cl. G06Q 30/00; H04M 3/51

(52) U.S. Cl. CPC G06Q 30/016; H04M 3/5175
USPC 705/304

(57) ABSTRACT

A method for a plurality of processors configured to perform steps in a map/reduce network operation adds incremental batch transformation of sequential measures recorded by time periods and uploaded asynchronously from their capture on mobile devices. The method creates and tracks measure states for each measure. The current recurrence of a measure is a transformation of selected past recurrences and measures. Measure state is propagated according to rules. The ID for a current measure is derived from the IDs of its cache measures and the IDs of its trigger measures. A batch incremental enrichment transforms one or more measures from one or more recurrences into at least one output measure that may be transformed again by the same or another batch incremental enrichment. The apparatus determines if the value needs to be overwritten with a newer value by the type of transformation, the recurrence id and the state.

### RELATED APPLICATION

This is a CIP of a co-pending application Ser. No. 14/142,204 filed Dec. 27, 2013 which claims the benefit of 61/769,188 filed Feb. 25, 2013 is incorporated in its entirety and derives its priority date therefrom.

### Background

It is known that map/reduce computing methods have been economical at processing large volumes of data. However, data which has been captured at one point in time and uploaded for processing at a different point in time presents a more difficult problem, especially for time sequenced measurements which are transformed by a chain of enrichments from other measures. Mobile operators typically have access to a wealth of data from their networks and some user-generated information, but they have little insight on what is happening on the device itself. Only device-sourced metrics can give operators a true representation of the performance of a device to help resolve device support issues and improve the consumer experience. Operators are constantly striving to increase service quality and customer satisfaction to improve the overall customer experience. There is a great need to focus on improved care, particularly from the consumer's perspective.

What is needed is a customer care solution aimed at reducing the duration of customer support calls, decreasing the number of no-fault-found device returns, and improving the consumer experience with explicit permission from the end user, and without tangible impact on battery drain rates, data plan usage or user experience.

Thus it can be appreciated that what is needed is a general capability to perform batch processing of continually expanding datasets in a scalable manner in a Hadoop or Map/Reduce system.

Because end-users further have the ability to install many apps, no two mobile wireless devices are likely to be configured the same way more than 24 hours after any end-user takes charge of them.

Thus it can be difficult to first determine what is “normal” for millions of mobile wireless devices, all slightly different. Then for any individual mobile wireless device user, is the hardware, software, or communication channel substantially divergent from normal for like peers or within an acceptable range.

It is impractical to calculate the many dimensions of performance for each of millions of devices and group them by similarity to obtain averages. So how can the performance of an individual mobile wireless device be meaningfully compared?

### SUMMARY OF THE INVENTION

A method for a plurality of processors configured to perform steps in a map/reduce network operation adds economical incremental batch transformation of sequential measures recorded by time periods and uploaded asynchronously from their capture on mobile devices. The method creates and tracks measure states for each measure. Measures may have multiple past recurrences and one current recurrence. The current recurrence of a measure is a transformation of selected past recurrences and measures whose measure state is new. Measure state is propagated according to rules. The ID for a current measure is derived from the IDs of its cache measures and the IDs of its trigger measures.

Measurements are taken at each mobile wireless device and subsequently stored and aggregated.

Each member of a mobile wireless population is configured with a data collection agent, which collects data according to a modifiable data collection profile. The collected data are packaged and uploaded to a distributed store. Massive parallel transformations anonymize, aggregate, and abstract the performance characteristics in a multi-dimensional space.

A package of metrics is generated by an agent on a wireless device which was triggered to record the metrics and triggered to generate the package for transmission to a collector.

A hash of a package serves as substantially unique identifier for each of the metrics assembled into the package.

A collection of packages received between a first time point and a second time point is defined as a recurrence and is transformed to measures in parallel. The same type of measures which have the same unique identifier are derived from the same package and are redundant with one another.

A measure has a recurrence id and a freshness property initially set to new when transformed from a package.

Batch incremental enrichments transform one or more measures from one or more recurrences into at least one output measure which may be transformed again by the same or another batch incremental enrichment. If an enrichment transform processes only the current recurrence, it is recurrence-insensitive. If an enrichment transform processes a plurality of recurrences it is recurrence-sensitive. Each enrichment transformation determines the freshness property of its output and the recurrence id.

When an enrichment transformation determines that its output is substantially unchanged, the result may be discarded rather than stored to non-transitory computer readable media.

Depending on the type of transformation, the recurrence id and the state determines if the value needs to be overwritten with a newer value.

### BRIEF DESCRIPTION OF DRAWINGS

The present invention will be understood more fully from the detailed description given below and from the accompanying drawings of various embodiments of the invention, which, however, should not be taken to limit the invention to the specific embodiments, but are for explanation and understanding only.

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram of an exemplary computer system.

FIG. 2 is a flowchart of executable instructions to cause a processor to perform a method.

### DETAILED DISCLOSURE OF EMBODIMENTS

An incremental batch process which does not completely reprocess the last 30 days of data in each daily batch run controls a processor to perform the steps: retaining intermediate measures; fully processing data collected in the period (e.g. 24 hours) since last incremental batch process; reprocess intermediate measures when used to build potential new measure; reprocess intermediate measures when used to build a measure that may be changed; replace obsolete measure; provide unique ID for each generated measure; determining when a generated measure cannot have changed.

A method for incrementally enriching measures within a processor coupled to non-transitory data storage, includes: receiving a previously enriched measure; receiving a measure produced in a current recurrence(fresh measures); determining the earliest period (day) with fresh measures; reading fresh measures from storage; controlling a fresh flag on output records; writing out only output measures which are fresh.

In an embodiment, the method further includes: setting a flag to produce a non-fresh measure when the output is consumed by another enrichment process; setting a recurrence attribute; setting a new attribute to identify rows to delete; creating a measure-to-delete object containing at least one id.

A distributed file system contains multiple large blocks of sequentially received and stored data collection packages transmitted from a plurality of wireless devices on conditions specified in their respective data collection packages. The date and time of the reception/storage is subsequent and asynchronous from the collection of the data at the wireless mobile device.

To take advantage of the large array of available compute engines, the problem is broken up to provision metrics to measures transformations in parallel to a large number of compute engines local to the data packages which minimizes data transfer. The same or other compute engines operate on a plurality of measures output from the metrics to measures transformation to enrich the measures by applying correlations based on time. As data packages are presented to the metrics to measures transformations in sequential time, the enrichments can continue to improve the information by inferences based on correlations of events in time sequence.

From the continuously improving enriched measures, certain Key Performance Indicators (KPI) are derived. A third set of transformations, which may be assigned to compute engines, operate on the enriched measures to generate the KPI for the population of wireless mobile devices as a whole or for selected subsets.

In a first mode, the results are aggregated at every stage. Compute nodes may operate on more than one task, KPI generation, enrichment, or transforming metrics to measures as assigned.

In a conventional Map/Reduce environment, data is unstructured and streamed to a plurality of parallel localized nodes. The massively parallel operation of all steps is accomplished by the stages of Map and subsequent Reduce.

There are three types of patterns detected:
Causality. A first event which generally precedes a second event within a range of time or events is associated as having a cause and effect relationship.
Assertion/Assumption. A first event is assumed to be successful by assertion unless an objection is signaled within a range of time or events. Until a second event is received which “objects” to the first event, the first event is considered successful. In this case, silence implies success or validity.
Propinquity. Two events may not be simultaneous or their it may not be possible to determine their position in absolute time but within a range they may be determined as propinquitous.

A conventional map reduce architecture provides a large number of nodes which enjoy fast access to a sub part of a distributed file system. Because the map reduce process breaks a problem up, many nodes operate the same transformation in parallel. In our embodiment, data is transformed in time sequence by one of many local nodes and the result is returned to the initiating node for reduce operation. The advantage of conventional map reduce is that it takes advantage of many inexpensive resources to attack a big data network characterization problem.

One aspect of the invention is that the method executes either in a distributed Hadoop map/reduce environment or in an in-memory environment.

One aspect of the invention is a framework for producing rich facts and KPIs (Key Performance Indicators) from metrics collected from wireless devices. The framework provides both Java APIs and an XML syntax for expressing the particular facts and KPIs to produce. Each particular executable instantiation of these Java and XML artifacts is referred to below as a flow. This framework supports different deployment models for a flow:
Full Restatement (Hadoop Map/Reduce)
Incremental Statement (Hadoop Map/Reduce plus incremental processing)

All deployment models concern the manner in which the huge amount of data from wireless devices gets divided up into manageable amounts that can be computed. The invention addresses the previously unsolved challenge to ensure consistent results when dividing the data into chunks, as well as to achieve acceptable turn-around time (measured in hours for batch and seconds for on-demand).

Even with conventional Map/Reduce, it can take 24 hours or more to process 30 days of data for a large customer on a medium-sized grid. For this reason, the invention provides support for incremental statement which doesn't completely reprocess the last 30 days of data in each daily batch run.

Intermediate measures are normally discarded from memory after each execution of the flow. Injected measures are produced only during the first execution of the flow. Any enriched measure that is produced solely from injected measures will also be produced only during the first execution of the flow. If such measures are used only as direct inputs, then they will be discarded from memory after the first execution of the flow. (Note that the measure definition that was initialized with the direct input measures will have some or all that information in its own hash map). But if an injected measure is processed as bucketed input to an enrichment that also consumes customer-related packages, as in a join cached measure, then that intermediate output will be retained and be completely reprocessed in every execution of a flow.

Instead the invention fully processes the data collected in the 24 hours since the last incremental statement, and combines it with data collected in the 30 previous daily batch runs. But because a large amount of data gets correlated or aggregated across day boundaries, and because a lot of the data that we collect each day reflect events that occurred on the wireless device several days or more earlier, it is extremely challenging to figure out what computations performed on prior days need to be redone today.

Injected measures are produced only during the first execution of the flow. Any enriched measure that is produced solely from injected measures will also be produced only during the first execution of the flow. If such measures are used only as direct inputs then they will be discarded from memory after the first execution of the flow. But if an injected measure is processed as bucketed input to an enrichment that also consumes customer-related packages, then that intermediate output will be retained and be completely reprocessed in every execution of a flow.

Incremental processing is required in order to reduce flow execution time. The ideal goal is to ensure that execution time does not increase as the volume of historic data that has previously been processed grows.
a. Only generate measures that may be new or may have changed
b. Minimize the number of regenerated measures that didn't change
c. Reprocess intermediate measures produced by previous runs if they are used to build a potential new measure or a measure that may have changed
d. Minimize the number of intermediate measures reprocessed that don't actually produce a new or changed measure
e. Avoid generation of duplicate measures
f. Ensure that each regenerated measure that changed replaces the obsolete measure in subsequent processing and in the output
g. Ensure that each generated measure has a unique ID

Some of the known challenges that may impact the design are:
The same packages can be uploaded more than once by a device. The machinery cannot assume that a measure is new simply because the upload has not been processed before. The measure ID cannot include the upload ID unless some other provision is made to eliminate measures produced from any earlier uploads of the same package.
A measure can be enriched with a measure that occurs at a later time. Such measures require reprocessing of some of the triggering measures produced by earlier runs.
A measure can be enriched with a measure that occurs at an earlier time. Such measures require reprocessing of some of the cached measures produced by earlier runs.
In order to avoid reprocessing of all measures, it is essential that time limits be set on enrichments.
Cascading enrichments have an additive effect on the time window for individual measures.
The reprocessing window has to take into account the delay between the events that produce the measure and the upload.

Because upload latency can be extremely large and is highly variable, in order to meet goal it is highly desirable to set the reprocessing window independently for different subsets of measures. As the upload latency varies by device, compute the upload latency independently for each device, during each recurrence of the flow.

Usually enriched measures will inherit their ID from the triggering measure. But measures that have more than one possible trigger won't have the same ID on a subsequent run if the chosen trigger for that measure did not exist in the prior run, but an alternate trigger did exist. This presents a challenge for meeting objective [6].

It can be expensive to eliminate duplicates in a later stage of processing. Therefore it is desirable to be able determine if a generated measure is unchanged without examining prior outputs. This is known for reprocessed measures. This information could be propagated to enriched measures, but must be combined from all input measures.

A method for incremental processing in sequential (time-based) enrichments:

In order for enrichments to run incrementally, they must be passed all measures produced in this recurrence, plus some measures from prior recurrences to be reprocessed. As will become evident in the following discussion, in order to implement any optimizations, the enrichments must be able to distinguish the measures generated in this recurrence from the measures being reprocessed.

Not all measures produced by enrichments in this recurrence are new. Some are replacements (updates) of existing measures. To avoid confusion therefore, this disclosure refers to the measures produced in this recurrence as fresh measures, regardless of whether they are new or not. Fresh measures produced by measure factories can be assumed to be new (provided that they don't come from a new wireless device upload containing a duplicate package), but fresh measures produced later in the flow may or may not be new.

It is essential to enrichments that they have the same output format as their input format. Enrichments can be applied on top of enrichments. Enrichments shall produce their incremental outputs in the same format and structure as the incremental measure factory stage.

At the beginning of each enrichment stage, the platform must determine how much data from prior recurrences must be reprocessed.

The earliest day with fresh measures can easily be determined from the incremental outputs produced in prior stages simply by traversing the incremental outputs folders. At the beginning of each enrichment stage, the earliest reprocessing date for each measure is determined and passed into the input-path-gathering machinery to limit the measures being read. All inputs for a particular alias, since this earliest reprocessing date from all prior recurrences, is passed to the flow.

In order to avoid generating unnecessary work in subsequent stages, the enrichment stage does not generate an output measure that exactly duplicates a measure produced by an earlier recurrence. If that measure is outside the time window for this recurrence it isn't needed. If it is within the time-window for this recurrence, it will be input in the next stage from the previous recurrence produced by this enrichment stage.

The invention avoids regenerating any redundant measures in the enrichment stage by adding a flag to each measure that indicates that the measure is fresh. All input measures read from the prior recurrences are not fresh. All measures read from the current recurrence are marked as fresh. Each time that the enrichment generates an output record, it checks the flag on the triggering measure and all cached measures. If any of them are fresh, the output measure is marked fresh. When the output measures are written out to the recurrence, those that are not marked fresh are skipped.

Even though these measures are not written, enrichments do need to produce the non-fresh output measures if another enrichment in the enrichment chain for that stage consumes that measure. Therefore during initialization the framework will set a flag in each enrichment that indicates whether non-fresh measures should be generated. This flag is set if the output alias is consumed by another enrichment within the same stage. During the execution cycle, each time that a new triggering measure is identified all the cachers are updated before generating the measure. At this point we can determine whether any of the selected input measures are fresh. If any are fresh, the output measure is marked fresh and generated. Otherwise, if non-fresh measures are requested, the measure is generated as not fresh. Otherwise we skip the remaining steps to generate the measure, such as the derivation of attributes. This optimization is called non-fresh measure suppression.

A delayed upload from a single device affects the input window for all aliases produced from that upload. For this reason, many individual reduce buckets will begin with a large number of non-fresh measures. All the measures produced before any of the cachers hit the first non-fresh measure in the bucket will be non-fresh. Non-fresh-measure suppression will dispose of those input measures quickly unless they feed into a chained enrichment. Non-fresh-measure suppression also efficiently disposes of many measures encountered following the first non-fresh measure.

In an embodiment the method determines a narrower time window for each individual bucket (that is, typically, for each device). The framework could pre-iterate through the bucket to find the earliest fresh measure of each type and feed those dates into Derivation Window Map. Then the framework would discard from the bucket all measures that occur before the earliest reprocessing date for each alias returned by the Derivation Window Map. This time-window narrowing optimization, boosts performance when enrichments are chained, but provide no measurable benefit for unchained enrichments beyond that already obtained by non-fresh measure suppression. This optimization also requires memory to buffer the measures. Since chained enrichments already require a large amount of memory to buffer the chained output measures produced, the extra memory needed to narrow the time window would be available at the right time, the beginning of the bucket processing cycle. Therefore, this optimization should be applied only when enrichments in the stage are chained. Even then, the benefit of time-window-narrowing may not be great, as typical enrichments are not very compute intensive. So this optimization is not essential.

Note that the fresh measure attribute is an attribute of in-flight measures and should not be persisted. When persisted measures are input, they are marked fresh if-and-only-if they are read from the current recurrence.

As we have seen above, for enrichments it does not generally matter whether a fresh measure represents a new measure or an updated measure. But it might be useful to later stages of the flow to be able to distinguish them. This distinction might also be useful for load measurement, auditing, and debugging. At the time that an enrichment marks an output measure as fresh, it will also mark that measure as “new” if the triggering measure is marked new. This “new” attribute has to be persisted to be computed correctly or to be useful in any way. Input measures would be marked new only if the persisted measure had the new attribute and the measure comes from the current recurrence.

Any fresh measure in an enrichment bucket that is not new will almost certainly be a duplicate of another measure in the bucket being reprocessed from a prior recurrence. In fact, it might even have duplicates from more than one prior recurrence if the measure was refreshed previously. The enrichment machinery must remove these duplicates, keeping the fresh measure. There will also be duplicates of measures from prior recurrences when there is no fresh measure for this run. It is clear therefore that the measure must also have a recurrence attribute, so that the enrichment knows which instance to keep when it eliminates duplicates in the in the input bucket.

The secondary sort key ensures that all duplicate measures will be ordered consecutively in the input bucket. This makes it easy for the framework to eliminate all but the most recent measure. The recurrence attribute is set dynamically when the input record is read from the recurrence, and is used only to eliminate the duplicate measures from the input bucket. It will not be propagated to output measures. By eliminating duplicates in the input bucket, duplicate enriched records are not passed down the enrichment chain, or persisted within the output of a single recurrence.

The same duplicate detection algorithm also serves to eliminate duplicates caused by repeated uploads from the same device. The machinery to identify unique measures can be based on some combination of measure time, alias name, and package ID (in the original sense of package hash), but not include upload ID. The measure time and package ID are always propagated to enriched measures from the triggering measure.

How do we handle enrichments with more than one trigger? In this case we need to ensure when we generate a fresh measure that any measure generated by one of the alternate triggers in a prior run can be eliminated by downstream consumers of this measure. We know what possible prior keys the measure might have been assigned by looking at the measures that have been cached when the fresh output measure is generated. We could build a list of the alternate IDs that need to be deleted that is persisted as a byproduct of this stage. We only need to put the alternate trigger ID on this list when both the primary and alternate triggers are present. The same logic can be extended to measures with multiple alternate triggers.

This list is shortened by using a “new” attribute. Then the measure with the alternate ID must be deleted if the trigger is new and the cached measure is not new. But in that case, can we simply keep the original ID—that of the original trigger? No, we cannot, because on a subsequent recurrence, when neither trigger is new, we would not be able to tell which ID had been previously assigned.

This list of ids to delete must be available to any direct consumer of this output alias. If this alias goes directly into fact storage, the fact storage machinery must delete the rows enumerated in the list. But if this alias is consumed by another enrichment, that enrichment must eliminate the replaced input measures during the map/reduce. In addition, this downstream enrichment must determine if the ID-to-delete may have been propagated to the id of one of its output aliases (i.e., when the alias is a primary or alternate trigger of the enrichment), and add that derived ID to its own list of ids-to-delete. If the downstream enrichment is a chained enrichment, it need not worry about eliminating the replaced input measure from its input buffer, but it still has to propagate ids for affected triggers to its own list of IDs-to-delete.

In an embodiment, the method also includes: Whenever an enrichment generates a measure from a new primary trigger while using an non-new alternate trigger as a cached measure, creating a measure-to-delete object with the deleted id. This measure-to-delete is passed to the collector and down the enrichment chain, persisted along with the normal measures if that alias is persisted, and sorted in the proper sequence by the next enrichment(s) that consume it. Then when the measure iterator sees the measure-to-delete, the old measure to be deleted (if present) will be next in the buffer. In addition to removing the old measure, the framework method includes creating a new output measure-to-delete with the propagated ID, if the measure-to-delete object is for its triggering alias. This will be passed to the collector and down the enrichment chain. In this way deleted measures will be propagated through the flow to the fact storage stage. The fact storage component must act appropriately on each measure-to-delete in the input sequence file.

Non-sequential enrichments are enrichments that do not correlate measures based on time. However, they are almost always applied to triggering measures which have a time. Here is another method for incremental processing of non-sequential enrichments.

Most non-sequential enrichments produce a single output measure from each triggering measure and make limited use of cached measures. These enrichments do not affect the reprocessing time window. Incremental processing of these enrichments shall follow a simple append/replace/delete model. The output measure will be fresh if the triggering measure is fresh. The output measure will not be generated if the triggering measure is not fresh and there is no chained consumer of the measure. The output measure will be new if the triggering measure is new. Any measure-to-delete for the triggering alias will cause a measure-to-delete to be emitted for the output alias.

The following enrichments will follow this simple model, with some minor variations:

It is known that partial keys can work in HBase if the partial key can be turned into a key range. This can be achieved in this application by designing the primary key of the output table such that the high order portion of the key is derived directly from the triggering measure that generates multiple outputs. This is an entirely reasonable design constraint. In an embodiment for incremental processing of errors, the high order part of the key for the error table is the key of the measure that contains the error.

The same constraint must be assumed in order to process and propagate deletes with partial keys through other enrichments. The framework should enforce this constraint by generating a measure ID for all measures that includes the triggering measure ID as the high-order portion of the key. Processing deletes in the input of an enrichment does depend on iterating over the bucket contents in order. Deletes are either at the front of the bucket and cached by the enrichment, or inserted in the bucket just before the measure that it deletes. In an embodiment, the latter approach applies for the time-based enrichments, sorting the deletes by time. To support incremental processing, ALL non-sequential enrichments shall by default use a secondary sort key to ensure that triggering measures are sorted by the measure ID.

This ordering of inputs to support deletes is compatible with all enrichments that have been designed so far. In an embodiment when the need arises the method sorts all the deletes to the front of the bucket and cache them.

How to operate enrichments incrementally
Definition of terms
Recurrence
New measure
Regenerated measure
Deleted measure
Measure state
Fresh measure
Recurrence-sensitive
Triggering measure
What enrichments operate incrementally?
1. Each enrichment must indicate to the framework if it is recurrence-sensitive
2. Each enrichment must filter out all but the most recent recurrence of any input measure
3. Each enrichment must identify a sort order for input measures that groups different recurrences of the same measure
4. Each enrichment must assign a unique ID and time for each measure that never changes when the measure is regenerated
5. Each enrichment must record in each output measure the most recent recurrence of all input measures that contributed to the generation of this measure
6. Each enrichment must record in each output measure whether this measure is a restatement of a measure produced in an earlier recurrence
7. Each enrichment must generate a deleted output measure whenever it eliminates a measure as part of its restatement process
Enrichments with alternate triggers
Enrichments that produce multiple outputs
8. Each enrichment must propagate any deleted input measure that it receives if the measure that it deletes would have produced a distinct measure when it was previously processed
9. Each enrichment must avoid using a deleted input measure in the production of any measures other than a deleted output measure
10. Each recurrence-sensitive enrichment should indicate to the framework how far back in time to look for old measures to correlate to new measures

### What is Incremental Operation?

When a flow executes non-incrementally it processes all the input data received to date that will be reflected in the data displayed in the application. When a flow executes incrementally, it processes all new data that has been received since the last flow execution, plus only as much old data as is necessary to update the data that will be displayed in the application.

When processing data non-incrementally, processing time for most steps in the flow grows linearly as the volume of old data included in the application grows. Full incremental processing enables the flow to execute in time more in proportion to the amount of new data received since the last execution. The processing cost of including a large amount of historical data is dramatically reduced.

### How Does Incremental Processing Affect Enrichment Design?

The principal purpose of most enrichments is to correlate multiple measures. Every time new measures are added to the pool of measures being correlated some of those correlations are bound to change. For this reason enrichments must reprocess some input data and restate some output data previously generated. This process must be coordinated between different enrichments. Even the enrichments that do no correlation of measures must coordinate their activity with enrichments that do correlate measures. Every enrichment will be forced to reprocess restated measures produced by earlier enrichments, and must identify those measures as such. Every enrichment will be forced to regenerate measures that have not changed because they are needed by another enrichment in the same map/reduce stage that does restate output measures. From the start to the end of the enrichment portion of the flow new and restated measures must be differentiated so that at the end of the flow only new or modified data is inserted or updated into the database.

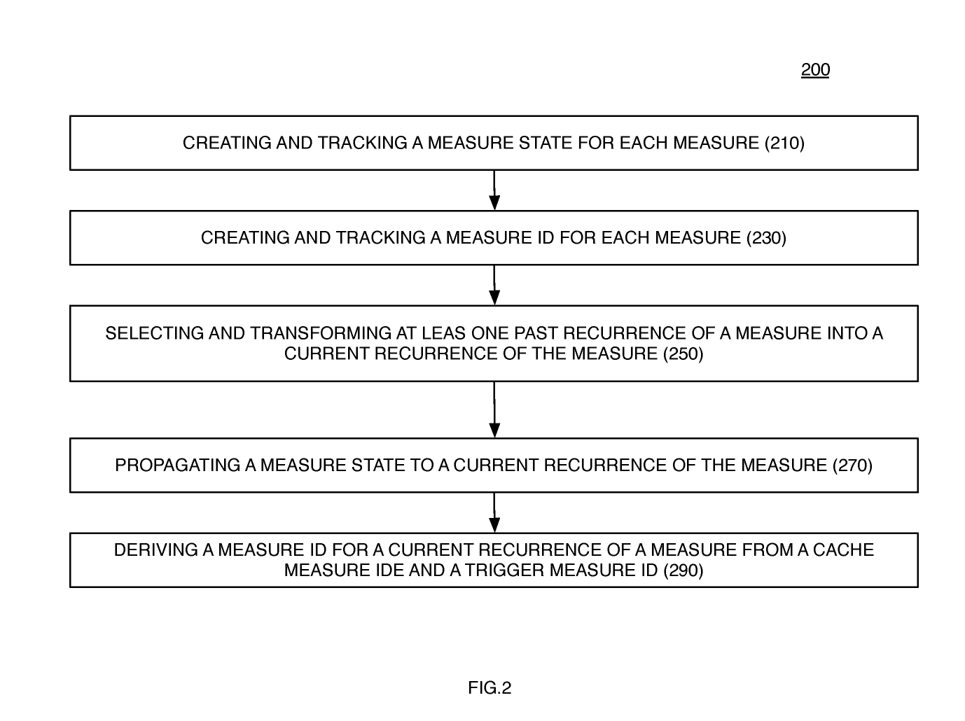

Referring now to FIG. 2, an exemplary embodiment of a method 200 causes a processor, by executing instructions stored in non-transitory media to transform measures by: creating and tracking a measure state for each measure 210; creating and tracking a measure ID for each measure 230; selecting and transforming at least one past recurrence of a measure into a current recurrence of the measure 250; propagating a measure state from a past recurrence to a current recurrence 270; and deriving a measure ID in a current recurrence from a cache measure and a trigger measure 290.

### Definitions

### Recurrence

A recurrence is one incremental execution of the flow. The current execution of the flow is the current recurrence. Prior executions of the flow whose output data is being combined with the input and output and output data of the current recurrence are called prior recurrences. The recurrence ID uniquely identifies a recurrence. It is a long value, derived from the time that the flow ran. Every measure has a recurrence attribute that identifies which recurrence of the flow the measure was generated in. If a measure must be reproduced by an enrichment entirely from inputs from prior recurrences, the output measure must have the recurrence ID that it would originally have had.

### New Measure

A new measure is a measure which is (or was) produced for the first time in the identified recurrence. A new measure is not necessarily new to the current recurrence. You have to look at the recurrence ID of the measure to determine that.

### Regenerated Measure

A regenerated measure is a restated measure that replaces a measure produced in a prior recurrence.

### Deleted Measure

A deleted measure is a measure that was generated in a prior recurrence and which is being removed in the identified recurrence.

### Measure State

Every measure has a measure state. The measure state is either New, Regenerated or Deleted. All three states are relative to the recurrence ID of the measure.

### Fresh Measure

A fresh measure is measure with the recurrence ID of the current recurrence. A fresh measure can be new, regenerated or deleted. We can also refer to fresh measures as current measures.

### Recurrence-Sensitive

An enrichment is recurrence-sensitive if receipt of a New measure sometimes causes a previously generated output measure to be restated. When this occurs the enrichment produces output measures with the state Regenerated or Deleted.

### Triggering Measure

The triggering measure is the input measure that causes an output measure to be produced. In most enrichments only one output measure is produced for each triggering measure. Other measures are usually referred to as cached measures.

A method for incremental operation of enrichments comprises: Indicating if it is recurrence-sensitive.

The framework will not reprocess inputs from prior recurrences if none of the enrichments in a map-reduce stage are recurrence-sensitive. Recurrence-insensitive enrichments do not escape the other incremental processing responsibilities of enrichments. They still must process regenerated and deleted measures. They must also reprocess measures from prior recurrences required by other enrichments in the same map-reduce stage.

Filtering out all but the most recent recurrence of any input measure whenever an enrichment stage processes inputs from prior recurrences, all enrichments executing in that stage will typically receive multiple instances of certain input measures from different recurrences. The enrichment must only use the input measure with the most recent recurrence. In an embodiment, the framework method comprises looking ahead one measure to determine if the measure it has in hand is made obsolete by the next measure in the stream. Identifying a sort order for input measures that groups different recurrences of the same measure.

Input measures to every enrichment must be sorted by measure ID so that measures with the same ID from multiple recurrences can be eliminated as the measures are iterated over during the reduce. Only the most recent recurrence of each measure is kept. Enrichments can and often do have other sort requirements that must be addressed around this requirement. For example, sequential enrichments sort on time, alias and measure ID. Assigning a unique ID and time for each measure that never changes when the measure is regenerated

Because enrichments often processed in time-sequence and duplicates from different recurrences are eliminated only when they are sorted consecutively, the time of a measure cannot change from one recurrence to the next. Enrichments normally maintain a unique and consistent time and ID on the output measures produced by inheriting the time and ID of the triggering measure. Recording in each output measure the most recent recurrence of all input measures that contributed to the generation of said output measure

The ability to distinguish fresh measures from non-fresh measures is at the core of all incremental processing optimizations. A fresh measure is one that has the recurrence ID of the current recurrence. The method ensures this core requirement by assigning to each output measure the largest recurrence ID from all the input measures contributing to the generation of that measure. Each enrichment must record in each output measure whether this measure is a restatement of a measure produced in an earlier recurrence

Many consumers of measures can minimize both the amount of work that they themselves perform, and the further work that they impose on their consumers, if they can differentiate measures that are new from measures that are regenerated. Measures that are new in the current recurrence do not impose as much burden on later consumers as measures regenerated in the current recurrence impose. Non-fresh measures impose the least amount of burden on later consumers. As relatively few fresh measures will be regenerated, performance is enhanced significantly by the ability to distinguish them.

Generally a measure is New in the current recurrence if the triggering measure is both New and Fresh. More precisely speaking, the measure is new in the recurrence assigned if the triggering measure is both new and from the same recurrence. An output measure is never marked new if the triggering measure is from an earlier recurrence than any of the cached measures that contribute to the output measure. Generating a deleted output measure whenever it eliminates a measure as part of its restatement process

There are two known types of enrichments that may delete measures as part of the restatement effort.

Generating a deleted output measure when an enrichment comprise alternate triggers:

In most use cases in which more than one measure can serve as the triggering measure, the primary triggering measure may become available in a later recurrence than an alternate triggering measure, causing the measure ID and time to change. In this case the enrichment must issue a deleted measure with the original measure ID.

Generating a deleted output measure when an Enrichment produces multiple outputs:

In embodiments, enrichments may produce a different number of output measures based on dependant attributes of the measure. Because these enrichments do not know the prior values of those attributes, they cannot know exactly what output measures they produced previously. These enrichments produce a deleted measure with the ID of the trigger, which serves as a partial ID of the measures that they previously produced. These deleted measures are produced when the triggering measure is regenerated. Propagating any deleted input measure that it receives if the measure that it deletes would have produced a distinct measure when it was previously processed.

Each consumer of enriched measures removes the deleted measures from its outputs. For example, in the output stage, deleted facts must be removed from the database. For enrichments much of the work of processing deleted measures is handled by restating the outputs that used those measures. The framework takes care of removing the corresponding measures from recurrences prior to the deleted measure while iterating over the input measures. But the deleted measure itself is passed to the enrichment for additional handling. If the deleted measure was a trigger, the enrichment produces a deleted output measure with the ID, time and recurrence ID of the deleted input measure. As a result, downstream consumers of measures will delete the corresponding measure produced by an enrichment in the prior recurrence. Preventing each enrichment from a deleted input measure in the production of any measures other than a deleted output measure.

The deleted measure serves to prevent the enrichment from seeing or using the corresponding measure from a prior recurrence. But the enrichment must be sure not to use the deleted measure to enrich some other non-deleted measure. This is accomplished in an embodiment simply by not putting the deleted measure into the measure cache. Indicating how far back in time to look for old measures to correlate to new measures by a recurrence-sensitive enrichment.

All enrichments that correlate measures over time have configurable time limits. These time limits determine how far back in time to look for corresponding input measures to reprocess.

An aspect of the invention is a plurality of method transformations which operate incrementally as well as in parallel on many packages from many devices within a time range and equally well on packages collected from distributed store for a single device. One aspect of the invention is to inform the user that the network where he is positioned is out of spec or over utilized and that it is referred to network planning. One aspect of the invention is to inform the user that his mobile wireless device is out of spec and that it needs to be repaired and replaced. A more useful aspect of the invention is to inform the user of updates or adjustments that could improve performance or to request further opt-in for diagnostic data.

### CONCLUSION

The method is distinguished from conventional batch processing by producing outputs formatted in the same manner as inputs.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

### An Exemplary Computer System

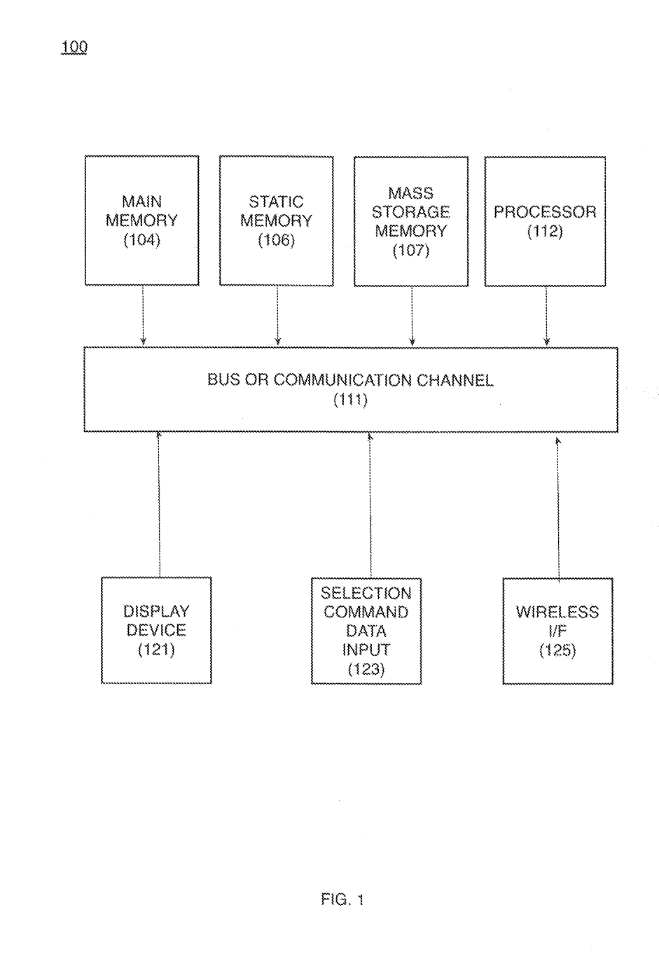

FIG. 1 is a block diagram of an exemplary computer system that may be used to perform one or more of the functions described herein. Referring to FIG. 1, computer system 100 may comprise an exemplary client 150 or server 100 computer system. Computer system 100 comprises a communication mechanism or bus 111 for communicating information, and a processor 112 coupled with bus 111 for processing information. Processor 112 includes a microprocessor, but is not limited to a microprocessor, such as for example, ARM™, Pentium™, etc.

System 100 further comprises a random access memory (RAM), or other dynamic storage device 104 (referred to as main memory) coupled to bus 111 for storing information and instructions to be executed by processor 112. Main memory 104 also may be used for storing temporary variables or other intermediate information during execution of instructions by processor 112.

Computer system 100 also comprises a read only memory (ROM) and/or other static storage device 106 coupled to bus 111 for storing static information and instructions for processor 112, and a non-transitory data storage device 107, such as a magnetic storage device or flash memory and its corresponding control circuits. Data storage device 107 is coupled to bus 111 for storing information and instructions.

Computer system 100 may further be coupled to a display device 121 such a flat panel display, coupled to bus 111 for displaying information to a computer user. Voice recognition, optical sensor, motion sensor, microphone, keyboard, touch screen input, and pointing devices may be attached to bus 111 or a wireless network for communicating selections and command and data input to processor 112.

Note that any or all of the components of system 100 and associated hardware may be used in the present invention. However, it can be appreciated that other configurations of the computer system may include some or all of the devices in one apparatus, a network, or a distributed cloud of processors.

A number of embodiments of the invention have been described. Nevertheless, it will be understood that various modifications may be made without departing from the spirit and scope of the invention. For example, other network topologies may be used. Accordingly, other embodiments are within the scope of the following claims.

We claim:

1. An incremental batch process at a processor which does not completely reprocess the last 30 days of data in each daily batch run comprising:
retaining intermediate measures;
fully processing data collected in the period since last incremental batch process;
reprocessing intermediate measures when used to build potential new measure;
reprocessing intermediate measures when used to build a measure that may be changed;
replacing an obsolete measure;
providing a unique ID for each generated measure;
and determining when a generated measure cannot have changed.

2. A method for incrementally enriching measures at a processor, comprising:
receiving from non-transitory data storage a previously enriched measure;
receiving a measure produced in a current recurrence( fresh measures);
determining the earliest period with fresh measures;
reading fresh measures from storage;
controlling a fresh flag on output records; and
writing out only output measures which are fresh.

3. The method of claim 2 further comprising:
setting a flag to produce a non-fresh measure when the output is consumed by another enrichment process;
setting a recurrence attribute;
setting a new attribute to identify rows to delete; and
creating a measure-to-delete object containing at least one id.

4. A method for a plurality of processors configured to perform steps in a map/reduce network operation to enable incremental batch transformation of sequential measures recorded by time periods and uploaded asynchronously from their capture on mobile devices, the method comprises:
creating and tracking a measure state for each measure;
creating and tracking a measure ID for each measure;
selecting and transforming at least one past recurrence of a measure into a current recurrence of the measure;
propagating a measure state from a past recurrence to a current recurrence; and
deriving a measure ID in a current recurrence from a cache measure and a trigger measure.
